(19) United States
(12) Patent Application Publication
(10) Pub. No.: US 2016/0353301 A1
(43) Pub. Date: Dec. 1, 2016

(54) WIRELESS COMMUNICATION APPARATUS AND METHOD OF OPERATING THE SAME

(71) Applicant: Samsung Electro-Mechanics Co., Ltd., Suwon-si (KR)

(72) Inventor: Kyoung Min KIM, Suwon-si (KR)

(73) Assignee: Samsung Electro-Mechanics Co., Ltd., Suwon-si (KR)

(21) Appl. No.: 15/043,091

(22) Filed: Feb. 12, 2016

(30) Foreign Application Priority Data
Jun. 1, 2015 (KR) 10-2015-0077405

(51) Int. Cl. H04W 24/08; H04L 29/08

(52) U.S. Cl. CPC H04W 24/08; H04L 69/324

(57) ABSTRACT

A wireless communication apparatus includes: a first multi-band communicator including a first media access control (MAC) layer for multi-band communications; a second multi-band communicator including a second MAC layer for the multi-band communications; antennas connected to the first and second multi-band communicators, respectively, and configured to transmit and receive data to and from access points connected to the antennas; a measurer connected to the antennas and configured to measure communication state information on at least two access points among the access points; and a switcher configured to control a switching operation of the first and second multi-band communicators to each other based on a measurement value of the measurer.

### CROSS-REFERENCE TO RELATED APPLICATION(S)

This application claims the benefit of Korean Patent Application No. 10-2015-0077405 filed on Jun. 1, 2015 in the Korean Intellectual Property Office, the entire disclosure of which is incorporated herein by reference for all purposes.

### BACKGROUND

1. Field

The following description relates to a wireless communication apparatus and a method of operating the same.

2. Description of Related Art

Today, a system used in mobile phones may perform communications by performing scanning using a hard handover and then performing an access operation through a listed-up access point and cutting off the previous access, then performing a connection to a new access point when connecting to another access point. This is due to communications of a Wi-Fi or wireless LAN (WLAN) system with one access point such as a 2.4 GHz-band access point or a 5 GHz-band access point which is already being used.

Therefore, the wireless communication apparatus requires a means for naturally switching a previous access to a new access.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a wireless communication apparatus includes: a first multi-band communicator including a first media access control (MAC) layer for multi-band communications; a second multi-band communicator including a second MAC layer for the multi-band communications; antennas connected to the first and second multi-band communicators, respectively, and configured to transmit and receive data to and from access points connected to the antennas; a measurer connected to the antennas and configured to measure communication state information on at least two access points among the access points; and a switcher configured to control a switching operation of the first and second multi-band communicators to each other based on a measurement value of the measurer.

The first multi-band communicator may include a first communication circuit and a second communication circuit having different communication frequency bands. The second multi-band communicator may include a third communication circuit and a fourth communication circuit having different communication frequency band. The first through fourth communication circuits may be controllable to be enabled by the switching operation of the switcher.

The antennas may include: a first antenna connected to the first and fourth communication circuits; and a second antenna connected to the second and third communication circuits.

The first and third communication circuits may be configured to transmit and receive a signal of a first band. The second and fourth communication circuits may be configured to transmit and receive a signal of a second band.

The first through fourth communication circuits may each correspond to physical layers in a one-to-one relationship.

The wireless communication apparatus may further include diplexers connected between the antennas and the first through fourth communication circuits and configured to pass signals of some communication frequency bands and cut off signals of other communication frequency bands.

The first and third communication circuits may have a frequency band of 2.4 GHz. The second and fourth communication circuits may have a frequency band of 5 GHz.

The measurer may be configured to measure at least one of a received signal strength indicator (RSSI) and a signal to noise ratio (SNR) as the communication state information.

The switcher may be configured to control the switching operation to make at least one of the first and second multi-band communicators communicate with an access point having a high received signal strength indicator or a high signal to noise ratio among the access points connected to the plurality of antennas.

At least one of the first and second multi-band communicators may perform the switching operation by a soft handover scheme.

According to another general aspect, a wireless communication apparatus includes: a multi-band communicator including media access control (MAC) layers each supporting one frequency band communication; an antenna connected to the multi-band communicator and configured to transmit and receive data to and from access points connected to the antenna; a measurer connected to the antenna and configured to measure communication state information on at least two access points among the access points; and a switcher configured to control a switching operation of the MAC layers to each other based on a measurement value of the measurer.

The multi-band communicator may include a first communication circuit and a second communication circuit having different communication frequency bands. The first and second communication circuits may be controllable to be enabled by the switching operation of the switcher.

The measurer may be configured to measure at least one of a received signal strength indicator (RSSI) and a signal to noise ratio (SNR) as the communication state information; and the switcher may be configured to control the switching operation to make the multi-band communicator communicate with an access point having a high received signal strength indicator or a high signal to noise ratio among the access points connected to the antenna.

The first communication circuit may have a communication frequency band of 2.4 GHz, and the second communication circuit may have a communication frequency band of 5 GHz.

Other features and aspects will be apparent from the following detailed description, the drawings, and the claims.

### BRIEF DESCRIPTION OF THE DRAWINGS

FIG. 1 is a diagram schematically illustrating a method of operating a wireless communication apparatus according to an embodiment.

FIG. 2 is a block diagram schematically illustrating a wireless communication apparatus according to an embodiment.

FIG. 3 is a block diagram illustrating in detail the multi-band communicator illustrated in FIG. 2.

FIG. 4 is a diagram showing a soft handover of the wireless communication apparatus according to an embodiment.

FIG. 5 is a diagram showing a switching operation of the wireless communication apparatus according to an embodiment.

FIG. 6 is a flow chart illustrating an example of the method of operating the wireless communication apparatus.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

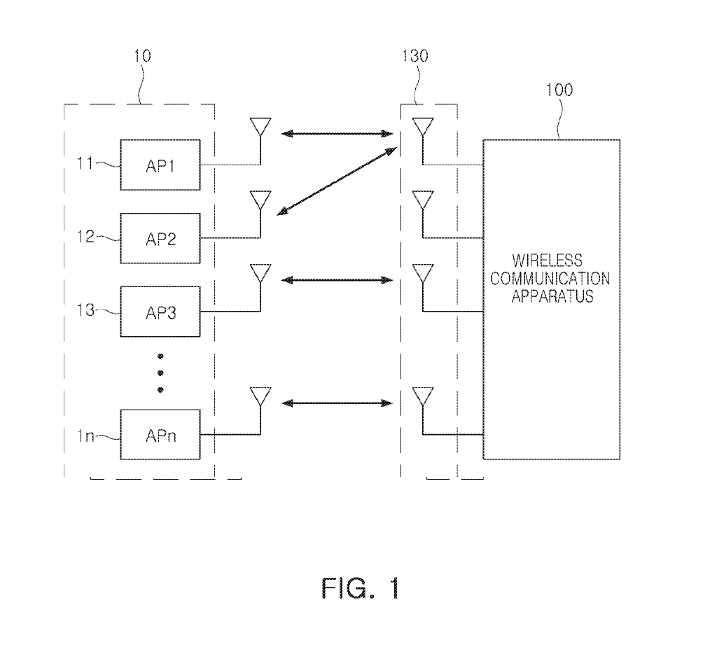

FIG. 1 is a diagram schematically illustrating a method of operating a wireless communication apparatus 100 according to an embodiment.

Referring to FIG. 1, the wireless communication apparatus 100 includes antennas 130 that communicate with a plurality of access points 10 including access points 11 through 1n, with n being a natural number of 1 or more. Hereinafter, the points are collectively referenced with reference numeral 10 and one of the access points is referenced by reference numeral 11, for example.

The wireless communication apparatus 100 may be a smartphone, a tablet PC, a laptop computer, a personal computer, one of various computer peripherals, or the like, and may form a communication channel with at least one of the access points 10 to transmit and receive data.

The access points 10 connect the wireless communication apparatuses 100 to wired apparatuses using Wi-Fi or Bluetooth related standards, or the like, in a computer network, and may be called a wireless access point (WAP). The access points 10 are generally connected to a router via a wired network, and relay data between wireless communication apparatuses 100 on a network. In this case, the wireless communication apparatuses 100 may use various services, such as a voice communication service, a moving picture service, and a data service, through one of the access points 10.

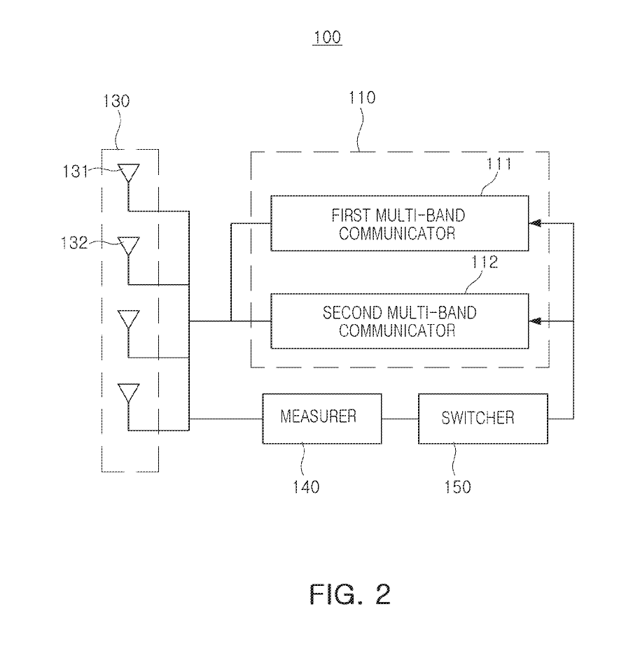

FIG. 2 is a block diagram schematically illustrating the wireless communication apparatus 100 according to an embodiment.

Referring to FIG. 2, the wireless communication apparatus 100 includes a multi-band communicator 110, the antennas 130, a measurer 140, and a switcher 150.

The multi-band communicator 110 includes media access control (MAC) layers to support multi-band communications. For example, the multi-band communicator 110 includes a first multi-band communicator 111 including a first MAC layer and a second multi-band communicator 112 including a second MAC layer.

For example, the multi-band communicator 110 has a real simultaneous dual band (RSDB) structure and simultaneously uses the dual band and communicates with at least two access points 10 using at least two MAC layers, unlike an existing Wi-Fi system communicating with one access point using only one MAC layer.

The antennas 130 are connected to the first and second multi-band communicators 111 and 112, respectively, to transmit data to and receive data from the access points 10. Here, the antennas 130 include at least a first antenna 131 and a second antenna 132.

The measurer 140 is connected to the antennas 130 to measure communication state information on at least two of the access points 10. For example, the measurer 140 receives the communication state information from an access point (e,g., access point 11) and receives data for measuring the communication state information. The measurer 140 processes the data to derive the communication state information. For example, the measurer 140 measures at least one of a received signal strength indicator (RSSI) and a signal to noise ratio (SNR) as the communication state information.

The switcher 150 controls a switching operation of the first and second multi-band communicators 111 and 112 based on the communication state information measured by the measurer 140. For example, the switcher 150 controls the switching operation to make the first and/or second multi-band communicators 111 and 112 communicate with an access point having the high (e.g., higher or highest) received signal strength indicator, or a higher or highest signal to noise ratio among the access points 10 connected to the antennas 130. For example, in the real simultaneous dual band (RSDB) structure, the switcher 150 allocates the access point to each MAC layer by a combination of the access point having the higher received signal strength indicator or signal to noise ratio among the searched access points 10 with the antennas, thereby performing communications. Therefore, the multi-band communicator 110 selects an access point 11 having good signal quality to smoothly perform a handover operation.

Accordingly, the wireless communication apparatus 100 increases throughput as a result of seamless communications upon the use of a multi-input multi-output (MIMO) scheme, and seamlessly performs the communication switching for the dual band communications upon the use of a single-input single-output (SISO) scheme.

Here, the MIMO scheme may be a scheme of transmitting different transmission signals from each of transmitting antennas installed at transmitting and receiving terminals to increase a channel capacity in a given bandwidth, and may increase a transmission data transmission rate gain and the channel capacity as many as the number of transmitting antennas, compared to the existing single input single output (SISO) scheme.

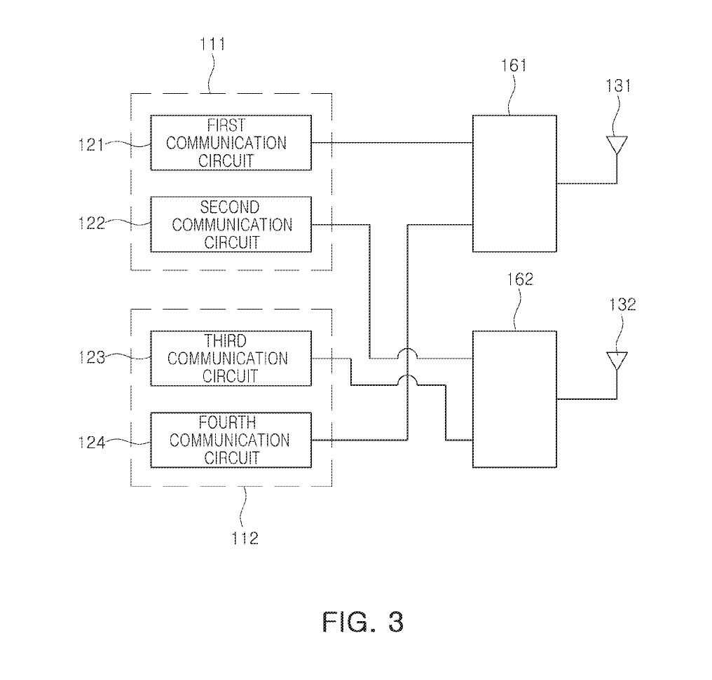

FIG. 3 is a block diagram illustrating in detail the multi-band communicator 110 illustrated in FIG. 2.

Referring to FIG. 3, the first multi-band communicator 111 includes a first communication circuit 121 and a second communication circuit 122 having different communication frequency bands, and the second multi-band communicator 112 includes a third communication circuit 123 and a fourth communication circuit 124 having different communication frequency bands. That is, the first and second communication circuits 121 and 122 correspond to the MAC layer included in the first multi-band communicator 111, and the third and fourth communication circuits 123 and 124 correspond to the MAC layer included in the second multi-band communicator 112.

For example, the first through fourth communication circuits 121, 122, 123, and 124 generate, process, and transmit signals for communications in digital and analog schemes. Here, the first through fourth communication circuits 121, 122, 123, and 124 are controlled to be enabled by the switching operation of the switcher 150. The enabled communication circuit performs the operations of the generation, the processing, the transmission, or the like, and the disabled communication circuit may stops the operations of the generation, the processing, the transmission, or the like.

The first and third communication circuits 121 and 123 transmit and receive a signal of a first band. For example, the first band may be a 2.4 GHz band.

The second and fourth communication circuits 122 and 124 transmit and receive a signal of a second band. For example, the second band may be a 5 GHz band.

Referring to FIG. 3, the antennas 130 include the first antenna 131 connected to the first and fourth communication circuits 121 and 124 and the second antenna 132 connected to the second and third communication circuits 122 and 123. That is, the first and second antennas 131 and 132 may each transmit the signal of the first band and/or the signal of the second band and may each be connected to the first and second multi-band communicators 111 and 112. Therefore, the wireless communication apparatus 100 may perform communications through the first and second antennas 131 and 132 for a co-band in the MIMO scheme, and may simultaneously perform communications through the first antenna 131 or the second antenna 132 for a dual band in the SISO scheme.

The wireless communication apparatus 100 includes diplexers 161 and 162 which are connected between the antennas 130 and the first through fourth communication circuits 121, 122, 123, and 124. The diplexers 161 and 162 pass signals of some bands and cut off signals of other bands.

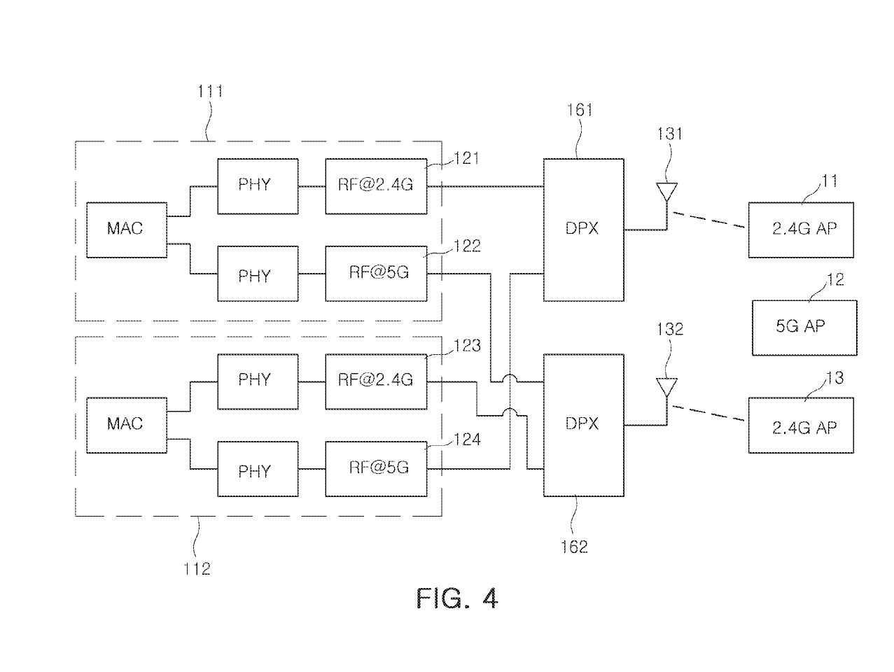

FIG. 4 is a diagram showing a soft handover of the wireless communication apparatus 100 according to an embodiment.

The first and/or second multi-band communicators 111 and 112 perform the switching operation by a soft handover scheme. Here, the soft handover scheme is defined as a scheme of performing an access operation to at least two access points once and naturally cutting off communications or handing over an access point connection to an access point having predominant communication state information while performing the communications.

When the Wi-Fi system is the MIMO scheme, the wireless communication apparatus 100 communicates with the 2.4 GHz-band access points 11 and 13 which are different from each other through the diplexer (DPX) and the first and second antennas 131 and 132. For example, when the communication state information on one access point 11 is weak, firmware of a MAC/PHY layer may perform the soft handover operation on the already scanned access point 13.

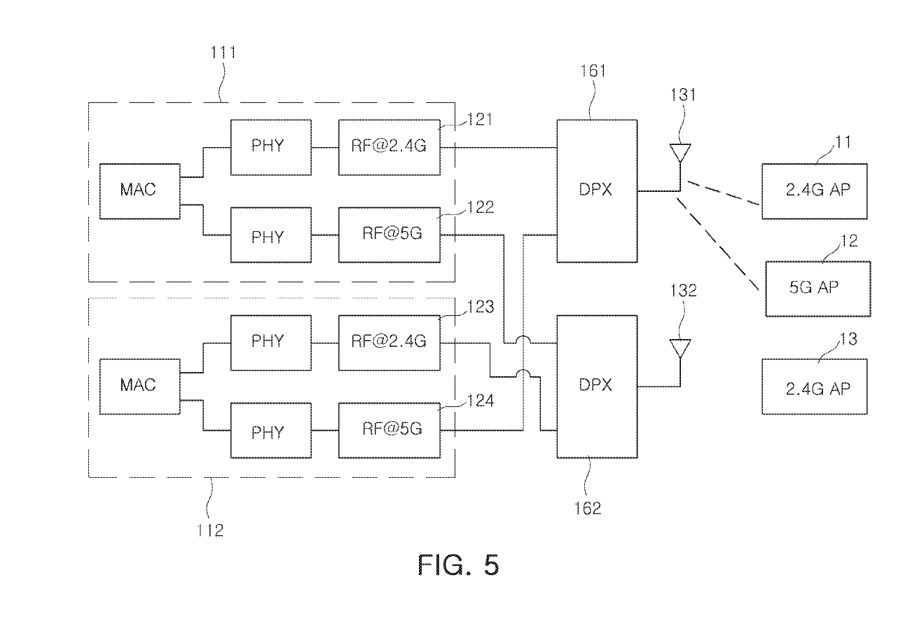

FIG. 5 is a diagram showing the switching operation of the wireless communication apparatus 100.

When the Wi-Fi system is the SISO scheme, the wireless communication apparatus 100 communicates with the 2.4 GHz-band access point 11 and the 5 GHz-band access point 12 through the first or second antenna 131 and 132. Here, the wireless communication apparatus 100 performs the handover operation from the 2.4 GHz communications to the 5 GHz communications or the 5 GHz communications to the 2.4 GHz communications upon the transmission and reception of data.

Referring to FIGS. 4 and 5, the first through fourth communication circuits 121, 122, 123, and 124 each correspond to physical layers (PHYs) in a one-to-one relationship. The physical layers PHYs serve as a bridge between the MAC layer and the communication circuit 121, 122, 123, or 124.

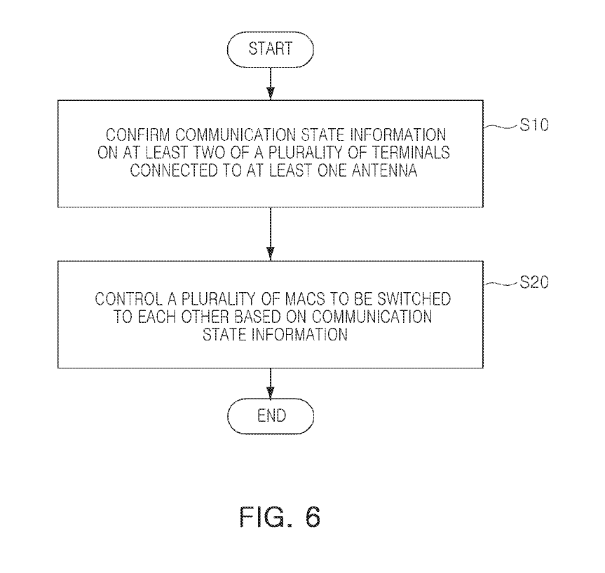

FIG. 6 is a flow chart illustrating the method of operating a wireless communication apparatus 100. Referring to FIG. 6, the method of operating a wireless communication apparatus includes confirming (S10) and controlling (S20) operations.

That is, the method of operating the wireless communication apparatus 100 for supporting multi-band communications by including a plurality of media access control (MAC) layers and at least one antenna 131, 132 is performed by confirming the communication state information on at least two of the access points 10 connected to the at least one antenna 131, 132 (S10) and controlling the plurality of MAC layers to be switched to each other based on the communication state information (S20).

Accordingly, the wireless communication apparatus 100 increases throughput as a result of seamless communications upon the use of the multi-input multi-output (MIMO) scheme and seamlessly performs the communication switching for the dual band communications upon the use of the single-input single-output (SISO) scheme.

The apparatuses, units, modules, devices, and other components (e.g., the first multi-band communicator 111, the second multi-band communicator 112, the measurer 140 and the switcher 150) illustrated in FIG. 2. that perform the operations described herein with respect to FIGS. 1 and 6 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1 and 6. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1 and 6 that perform the operations described herein with respect to FIG. 1 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless communication apparatus, comprising:
a first multi-band communicator comprising a first media access control (MAC) layer for multi-band communications;
a second multi-band communicator comprising a second MAC layer for the multi-band communications;
antennas connected to the first and second multi-band communicators, respectively, and configured to transmit and receive data to and from access points connected to the antennas;
a measurer connected to the antennas and configured to measure communication state information on at least two access points among the access points; and
a switcher configured to control a switching operation of the first and second multi-band communicators to each other based on a measurement value of the measurer.

2. The wireless communication apparatus of claim 1, wherein:
the first multi-band communicator comprises a first communication circuit and a second communication circuit having different communication frequency bands;
the second multi-band communicator comprises a third communication circuit and a fourth communication circuit having different communication frequency bands; and
the first through fourth communication circuits are controllable to be enabled by the switching operation of the switcher.

3. The wireless communication apparatus of claim 2, wherein the antennas comprise:
a first antenna connected to the first and fourth communication circuits; and
a second antenna connected to the second and third communication circuits.

4. The wireless communication apparatus of claim 3, wherein:
the first and third communication circuits are configured to transmit and receive a signal of a first band; and
the second and fourth communication circuits are configured to transmit and receive a signal of a second band.

5. The wireless communication apparatus of claim 2, wherein the first through fourth communication circuits each correspond to physical layers in a one-to-one relationship.

6. The wireless communication apparatus of claim 2, further comprising diplexers connected between the antennas and the first through fourth communication circuits and configured to pass signals of some communication frequency bands and cut off signals of other communication frequency bands.

7. The wireless communication apparatus of claim 2, wherein:
the first and third communication circuits have a frequency band of 2.4 GHz; and
the second and fourth communication circuits have a frequency band of 5 GHz.

8. The wireless communication apparatus of claim 1, wherein the measurer is configured to measure at least one of a received signal strength indicator (RSSI) and a signal to noise ratio (SNR) as the communication state information.

9. The wireless communication apparatus of claim 8, wherein the switcher is configured to control the switching operation to make at least one of the first and second multi-band communicators communicate with an access point having a high received signal strength indicator or a high signal to noise ratio among the access points connected to the plurality of antennas.

10. The wireless communication apparatus of claim 9, wherein at least one of the first and second multi-band communicators performs the switching operation by a soft handover scheme.

11. A wireless communication apparatus, comprising:
a multi-band communicator comprising media access control (MAC) layers each supporting one frequency band communication;
an antenna connected to the multi-band communicator and configured to transmit and receive data to and from access points connected to the antenna;
a measurer connected to the antenna and configured to measure communication state information on at least two access point among the access points; and
a switcher configured to control a switching operation of the MAC layers to each other based on a measurement value of the measurer.

12. The wireless communication apparatus of claim 11, wherein:
the multi-band communicator comprises a first communication circuit and a second communication circuit having different communication frequency bands; and
the first and second communication circuits are controllable to be enabled by the switching operation of the switcher.

13. The wireless communication apparatus of claim 11, wherein:
the measurer is configured to measure at least one of a received signal strength indicator (RSSI) and a signal to noise ratio (SNR) as the communication state information; and
the switcher is configured to control the switching operation to make the multi-band communicator communicate with an access point having a high received signal strength indicator or a high signal to noise ratio among the access points connected to the antenna.

14. The wireless communication apparatus of claim 12, wherein the first communication circuit has a communication frequency band of 2.4 GHz and the second communication circuit has a communication frequency band of 5 GHz.
